(19) United States
(12) Patent Application Publication
(10) Pub. No.: US 2025/0132492 A1
(43) Pub. Date: Apr. 24, 2025

(54) DUAL POLARIZED, WIDE BAND, LIGHT WEIGHT P-BAND ANTENNA ELEMENT AND ARRAY

(71) Applicant: United States of America as represented by the Administrator of NASA, Washington, DC (US)

(72) Inventors: Peter Seigner, Greenbelt, MD (US); Kenneth Segal, Greenbelt, MD (US); Rafael Rincon, Greenbelt, MD (US)

(21) Appl. No.: 18/383,195

(22) Filed: Oct. 24, 2023

(51) Int. Cl. H01Q 1/28; H01Q 1/38; H01Q 9/04

(52) U.S. Cl. CPC H01Q 1/288; H01Q 1/38; H01Q 9/0407

(57) ABSTRACT

The aspects of the disclosed embodiments are directed to a dual-polarized, wideband, lightweight P-band (435 MHz) antenna element and array for spaceborne radar applications. The antenna array was developed for planetary synthetic aperture radar (SAR) applications, but it is also suitable for earth science applications (i.e., airborne and earth orbiting radar) as well as other RF applications that require beam steering (e.g., communications). The antenna array is based on lightweight, low-profile antenna elements that form the building blocks of a manageable array panel that can in turn be used to build larger arrays consisting of multiple panels. The element design combines a novel, mostly planar conductor antenna element geometry with a robust light-weight composite material construction. The antenna element and array design, reported here for P-band operation, can be scaled to other frequencies (e.g., L-, S-, C-, or X-bands) for other radar applications where lightweight and beam agility are required.

The invention described herein was made by one or more employees of the United States Government, and may be manufactured and used by or for the Government for governmental purposes without the payment of any royalties thereon or therefore.

### FIELD

The aspects of the disclosed embodiments relate generally to antenna elements for spaceborne radar applications. In particular, the aspects of the disclosed embodiments are directed to a dual-polarized, wideband, lightweight P-band antenna element for spaceborne radar applications.

### BACKGROUND

Lunar and Mars science and exploration needs to be able to utilize the ground penetration abilities of P-band radio frequencies to study the sub-surface features at meter scale resolution. Due to the low P-band frequencies, an electrically large array for space applications needs to be robust enough to withstand the harsh outer space environment and stresses during launch, but at the same time needs to have minimal mass to reduce the launch costs. It would be advantageous to have a lightweight and beam-agile SAR for Lunar and Mars science and exploration that is able to utilize the ground penetration abilities of P-band radio frequencies to study the sub-surface features at meter-scale resolution.

Patch antennas were developed for ease of fabrication by exploiting printed circuit technology. Thin metal features can be printed or etched on supporting dielectric substrates. However, for wide band operation at P-band frequencies, the substrate needed for a patch antenna will be thick and massive. This is not desirable for certain science and space exploration. It would be advantageous to provide alternative ways to support a patch and slotted ground plane for wide band operation at P-band frequencies.

Accordingly, it would be desirable to provide a lightweight phased antenna array antenna that addresses at least some of the problems described above.

### SUMMARY

The aspects of the disclosed embodiments are directed to an electrically steerable, lightweight phased array antenna. The antenna element of the disclosed embodiments provides a dual polarized, wideband, lightweight P-band antenna element. This and other advantages of the disclosed embodiments are provided substantially as shown in, and/or described in connection with, at least one of the figures, as set forth in the independent claims. Further advantageous modifications can be found in the dependent claims.

According to a first aspect the disclosed embodiments are directed to an antenna element. In one embodiment, the antenna element includes a base plate; a ground element disposed above the base plate; and a patch antenna element disposed above the base plate.

In a possible implementation form, one or more slots are formed in corner regions of the ground plane element, wherein the one or more slots being arranged to form an arrow shape in the corner regions.

In a possible implementation form, a shape of the patch antenna element is conical.

In a possible implementation form, the patch antenna element is a planar element.

In a possible implementation form, the ground plane element is a planar element.

In a possible implementation form, the ground plane element includes a top face sheet and a bottom face sheet. A foam layer is disposed between the top face sheet and the bottom face sheet.

In a possible implementation form a capacitive metallic strip is disposed across a slot on the ground plane element.

In a possible implementation form the capacitive metallic strip is disposed on the top face sheet.

In a possible implementation form, the patch antenna element is configured as a plurality of faceted cone elements with a folded rim.

In a possible implementation form, the ground elements is configured as a plurality of faceted cone elements.

In a possible implementation form, a cavity is formed between the base plate element and the ground plate element.

In a possible implementation form, the cavity is configured as a closed cavity.

In a possible implementation form, the cavity is configured as an open cavity, where portions of the wall in corner regions are removed.

In a possible implementation form, a wall surrounds the cavity between the base plate and the ground plane element.

In a possible implementation form, the wall includes one or more elongated openings between sections of the cavity wall.

In a possible implementation form the patch element is suspended above the conical ground element with standoffs.

In a possible implementation form the ground element supported above the base element by standoffs. In a possible implementation form the standoffs supporting the ground element are metal or dielectric standoffs. The use of a metallic material rather than a dielectric material for the standoffs can change the resonant modes of the cavity.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the aspects of the disclosed embodiments will be described in more detail with reference to the example embodiments shown in the drawings, in which:

FIG. 1 illustrates an antenna element incorporating aspects of the disclosed embodiments, the antenna element being mounted on a metal base plate.

FIG. 2 illustrates a schematic view of an antenna element incorporating aspects of the disclosed embodiments with the metal base plate removed to allow a view inside the cavity.

FIG. 3 is a bottom side view of the antenna element shown in FIG. 2.

FIG. 4 illustrates the coax-to-strip transition for the antenna element of FIG. 1.

FIG. 5 is a cross-sectional view of the central cross-over region of the antenna element shown in FIG. 2.

FIG. 6 illustrates predicted active S-parameters for the antenna element of FIG. 1, in a large array, for different beam scan angles.

FIG. 7 illustrates a schematic view of an antenna element incorporating aspects of the disclosed embodiments, showing conical shaped patch and ground conductors supported by thin composite sheets.

FIG. 8 illustrates a bottom side view of the antenna element of FIG. 7, with the base removed to allow a view inside the open cavity.

FIG. 9 illustrates a side view of the antenna element shown in FIG. 7.

FIG. 10 illustrates a cross-sectional view showing details of the cross-over feed arrangement of the antenna element of FIG. 7.

FIG. 11 illustrates a cable assembly showing cable terminations soldered to feed cables and inserted into the pockets of a cross-over bracket.

FIG. 12 illustrates a schematic view of an antenna element incorporating aspects of the disclosed embodiments, with planar patch and ground conductors supported by composite sandwich layers.

FIG. 13 is a side cross-sectional view of the antenna element of FIG. 12.

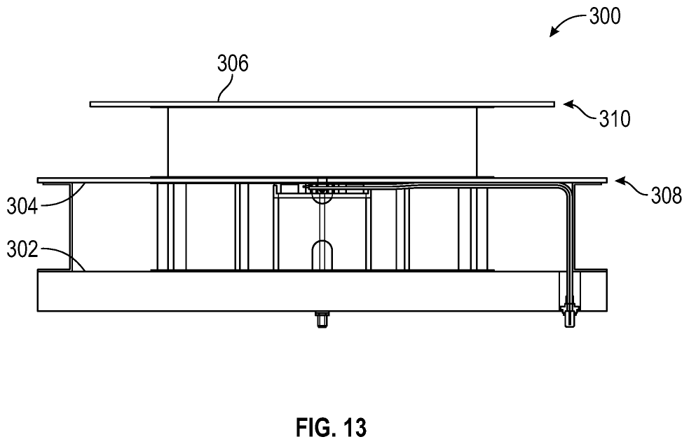

FIG. 14 is a detailed view of the cross-over feed arrangement for the antenna element of FIG. 12.

FIG. 15 is a bottom view of the antenna element shown in FIG. 12, with the base removed to allow a view inside the open cavity.

FIG. 16 illustrates predicted active S-parameters for an antenna element of FIG. 12 in a large array, for different beam scan angles. The cross-coupling S_{HV} parameter is not shown—it is below −45 dB for all cases.

FIG. 17 illustrates an array of five antenna elements of FIG. 1.

FIG. 18 illustrates an array of five antenna elements of FIG. 12, incorporating aspects of the disclosed embodiments.

FIG. 19 illustrates an array of forty antenna elements of FIG. 12, incorporating aspects of the disclosed embodiments.

### DETAILED DESCRIPTION

The following detailed description illustrates exemplary aspects of the disclosed embodiments and ways in which they can be implemented. Although some modes of carrying out the aspects of the disclosed embodiments have been disclosed, those skilled in the art would recognize that other embodiments for carrying out or practicing the aspects of the disclosed embodiments are also possible.

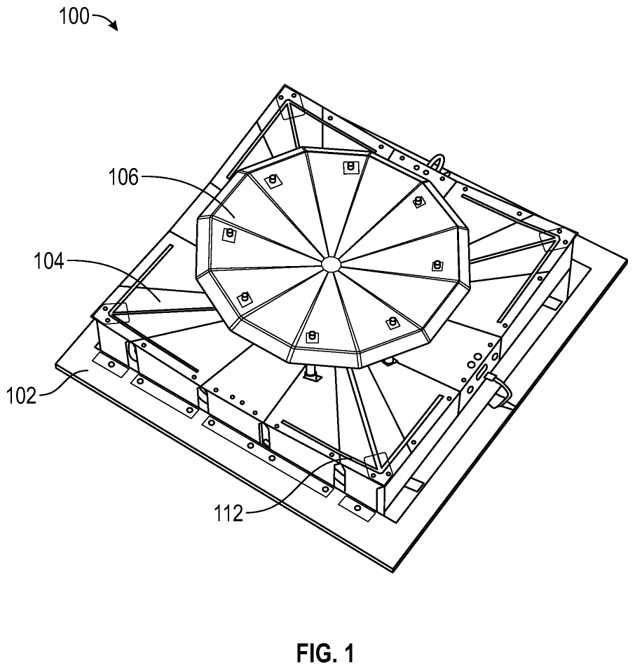

One example of an antenna element 100 incorporating aspects of the disclosed embodiments is illustrated in FIG. 1. In this example, the antenna element 100 generally includes non-planar metal structures with minimal dielectric support. The aspects of the disclosed embodiments provide a dual-polarized, wideband, lightweight P-band antenna element that is particularly suited for spaceborne radar applications.

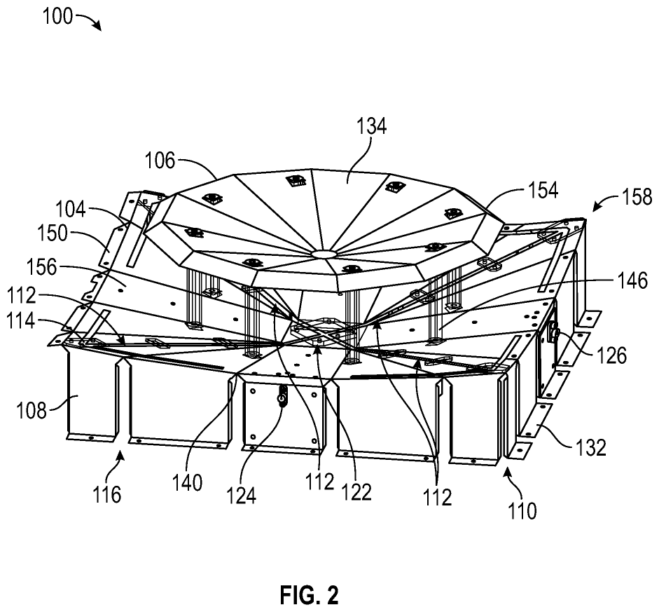

Referring to FIGS. 1 and 2, the antenna element 100 of the disclosed embodiments generally includes a base plate element 102, a ground plane element 104 disposed above or spaced-apart from the base plate 102 and a patch antenna element 106. The patch antenna element is disposed above or otherwise space-apart from the base plate 102. Dielectric spacers or standoffs 146 can be used to separate or space apart the patch antenna element 106 from the ground plane element 104.

In the example of FIGS. 1 and 2, a shape of the patch antenna element 106 is generally conical. The patch antenna element 106 is also shaped into or formed from faceted cone elements 134, with a folded rim 154. As shown in the example of FIG. 2, the patch element 106 is shaped and/or stamped out of a single flat piece of sheet metal. Alternatively, the patch element 106 can be cut with a slit to be joined up afterwards.

In one embodiment, the ground plane element 104, also referred to as a ground cone, is shaped into or formed from faceted cone elements 156. The faceted cone shape of the ground plane element 104 and the patch antenna element 106 provides enhanced mechanical stiffness.

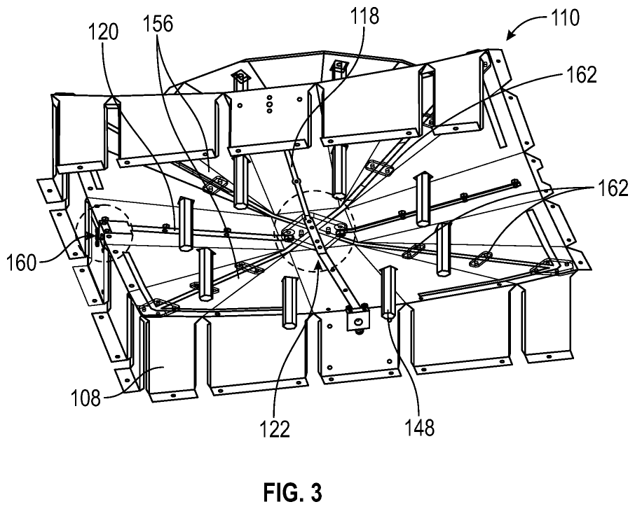

As shown in the example of FIGS. 2 and 3, walls 108 between the base element 102 and the ground plane element 104 are configured or shaped to form a cavity 110. The ground plane element 104 forms a cover for the cavity 110, referred to as a top cover or roof. The base plate element 102, shown in FIG. 1, forms a bottom cover or floor for the cavity 110.

Referring to FIGS. 2 and 3, the ground plane element 104 and the cavity walls 108 can be fashioned out of four separate pieces of flat sheet metal, each folded and bent to form a quadrant of the ground element 104 and one wall 108 of the cavity 110. The gaps between the quadrants form crossed slots 112. Due to the folds separating the facets 156 of the ground plane element, the cavity wall sections 108 require elongated openings 116 or slits. As shown in the example of FIG. 2, the elongated openings 116 generally align or meet up with fold lines 140 between the different facets 156. An additional fold can be added parallel to and near each straight edge for enhanced stiffness.

The openings 116 in the cavity wall 108 are only small fractions of a wavelength. Thus, the resultant cavity 110 is still essentially electrically closed, except for the crossed slots 112 in the ground element 104 that forms the roof of the cavity 110.

As also illustrated in the example of FIG. 1, with reference also to FIG. 2, in one embodiment, slots 112 are formed in the ground plane element 104. The slots 112 are generally arranged in the form of two crossed arrows in one or more of the corner regions 158 of the ground plane element 104. The tip 114 of the arrow formed by the different slots 112 generally allows a length of a specific slot 112 to be adjusted in the confined space, while preserving symmetry. As such, the slots 112 are configured to act as resonant elements coupled to the resonant patch element 106, thereby allowing second order broadband operation.

The antenna element 100 of the disclosed embodiments is generally configured as a crossed-slot coupled patch geometry. For informational purposes, the general operation mechanism of a cavity backed slot coupled patch antenna is described herein as follows.

A short slot, typically up to about half a wavelength in length, in a ground plane, is excited by a voltage source across the gap near the center of the slot. This can be arranged by using a transmission line strip bridging the gap to create a standing wave of electric fields in the slot. The slot couples electromagnetically to a close proximity thin metal patch parallel to the ground plane, setting up an electromagnetic resonance in the patch. The energy stored in the resonance finally bleeds away in the form of electromagnetic radiation. If the slot is also resonant, a second order coupled slot-patch resonance is created, which can be exploited to achieve a wider frequency band of operation compared to a single resonator. To prevent the slot from radiating into the hemisphere on the side of the ground plane opposite to the patch, a cavity can be constructed to block the slot off from that hemisphere. For dual polarization, a crossed slot is used to excite the patch in two orthogonal modes.

The antenna element 100 of the disclosed embodiments generally includes thin metal patch and ground plane geometries for the patch element 106 and the ground plane element 104. These constructions are attractive from a lightweight design perspective, as it requires a minimal amount of metal. The antenna element 100 of the disclosed embodiments utilizes altered geometries to enhance the structural performance enough to allow for minimal support structures, thereby minimizing the total mass.

### Embodiment 1

Referring to FIGS. 1-5, in this embodiment, the antenna element 100 is configured as a cavity-backed slot-coupled patch antenna design. The non-planar deformations, mainly the faceted cone shapes of the ground plane element 104 and the patch antenna element 106, provide enhanced mechanical stiffness for the antenna element 100. The base plate 102 in this example is made of metal. FIGS. 2 and 3 illustrate the antenna element 100 with the base plate 102 removed, in order to show the cavity 110.

In one embodiment, the metal plate parts of the antenna element 100 shown in FIG. 1 are cut and folded from thin, approximately 0.25 millimeter (mm) thick sheet metal. The elongated openings 116 in the cavity walls 108 shown in FIG. 2, for example, are added to allow forming one cavity wall and one triangular quarter of the ground plane element 104 from one piece of sheet metal.

The different parts of the antenna element 100 shown in FIG. 1 can be joined together using suitable fasteners. The fasteners are not shown in the figures, but are generally indicated by the location of the holes illustrated in the figures. In alternate embodiments, the different parts of the antenna element 100 can also be formed from fewer or even a single metal sheet using a mold and stamp tool, for example.

In one embodiment, the antenna element 100 includes tabs 150 along one or more sides of the antenna element 100. In the example of FIG. 2, the tabs 150 extend from the ground plane element 104. The tabs 150 are configured to enable connecting one antenna element 100 to an adjacent antenna element 100. In alternate embodiments, adjacent antenna elements 100 can be connected or joined together in any suitable manner to form an array of antenna elements, as is generally described herein.

Referring FIG. 3, the slots 112 are excited by feed strips 118, 120, generally referred to herein as vertical feed strips 118 and horizontal feed strips 120. In the example of FIG. 3, the feed strips 118, 120 are configured using classical microstrip geometry. As shown in FIGS. 2 and 3, the feed strips 118, 120 bridge the crossed slots 112 diagonally at the center region 122.

The symmetry in the construction of the feed strips 118, 120 preserves a high level of isolation between the V-feed port connection 124 and the H-feed port connection 126 shown in FIG. 2. In one embodiment, the level of isolation between the ports 124, 126 can be more than 40 dB.

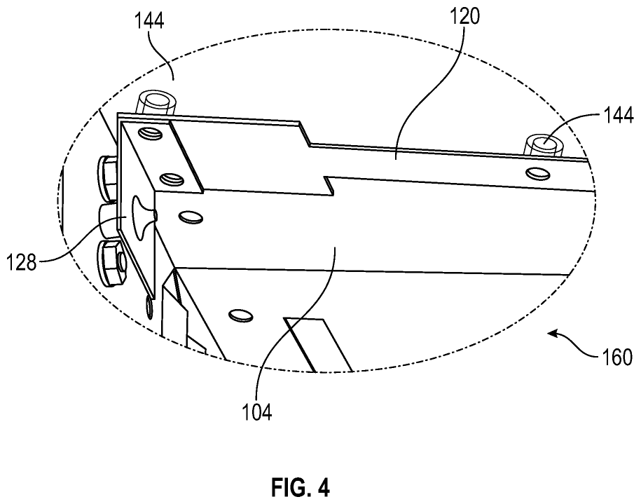

FIG. 4 illustrates the coax-to-strip transition 160 of FIG. 3. As shown in FIG. 4, the feed strip 120 can be soldered at one end to a standard coaxial connector pin via an elbow strip 128. In one embodiment, elbow strip 128 and feed strip 120 can be made or formed as a single piece. For convenience elbow strip 128 in this example is chosen to be an easily solderable metal, while strip 120 can be chosen to be a light weight metal such as aluminum which is not readily solderable. Although not shown, the feed strip 118 can also be soldered at one end to a standard coaxial connector pin via an elbow strip in a similar manner.

The other end of the feed strip 120, and similarly feed strip 118, is left open, roughly a quarter wavelength long from the slot cross-over region 122 shown in FIG. 3. Strip sections with varying width can be used to provide impedance matching of approximately 50 Ohms (Ω) at the connectors 124, 126.

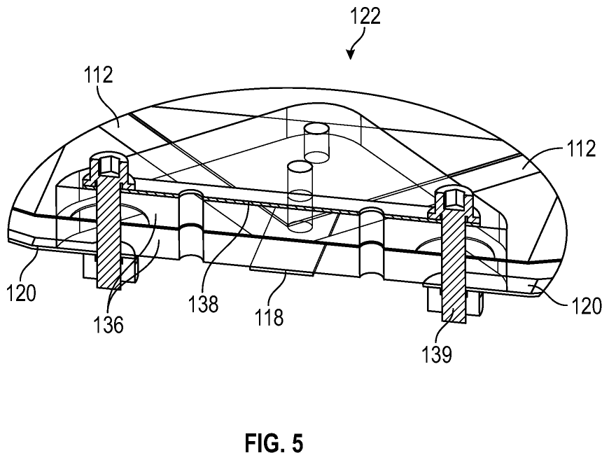

A detail cross-sectional view of the cross-over region 122 is illustrated in FIG. 5. As shown in this example, the cross-over region 122 includes cross-over dielectric brackets 136 that are used to support the cross-over portion 138 of the horizontal feed strip 120. Conducting fasteners 139 provides electric connectivity between strip parts 138 and 120.

Where electrical contact between parts of the antenna element 100 is not allowed, dielectric brackets can be used to hold or connect the parts together. For example, as shown in FIG. 4, low profile dielectric standoffs 144 are used to suspend the V-feed strip 118 and the H-feed strip 120 from the ground element 104.

As shown in FIG. 2, the conical patch element 106 is suspended above the conical ground element 104 with dielectric standoffs 146. As shown in FIG. 3, the ground element 104 is further supported above the base element 102 by metal or dielectric standoffs 148. The use of a metallic material rather than a dielectric material for the standoffs 148 can change the resonant modes of the cavity 110. In one embodiment, the standoffs 148 can be disposed directly below the dielectric patch standoffs 146. Dielectric clips and supports 162 shown in FIG. 3 can be used across the crossed slots 112 in the ground plane element 104 to provide further support.

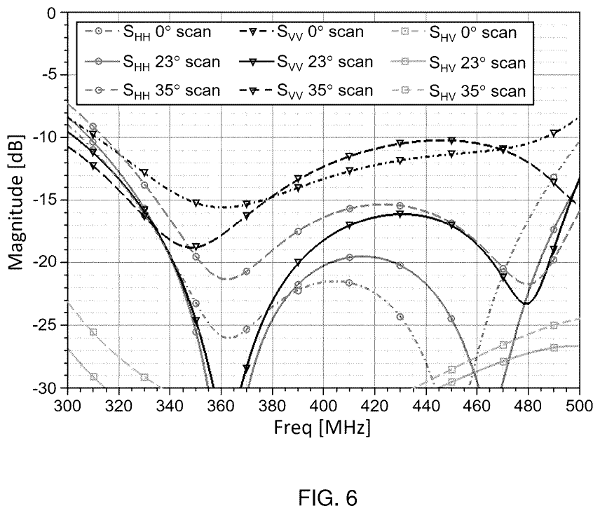

The predicted active S-parameter performance or active reflection coefficients at the ports 124, 126 of an antenna element 100 of the disclosed embodiments, placed in an arbitrary large array, is shown in FIG. 6. It shows that for up to 35 degree off-boresight beam scanning, the active S-parameters are below −9 dB over a 310 Megahertz (MHz)-495 MHz band. Lower port reflection levels imply that a larger fraction of the input signal power is transferred to the antenna element, and barring internal losses, is ultimately transmitted.

### Embodiment 2

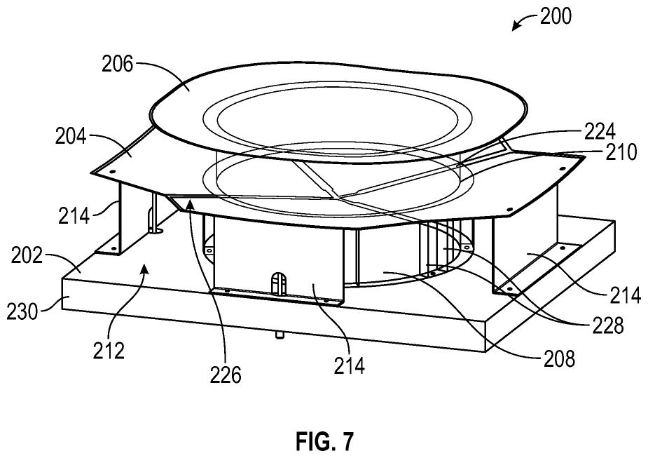

Referring to FIG. 7, one example of an antenna element 200 according to the aspects of the disclosed embodiments is illustrated. In this example, the antenna element 200 is configured as a non-planer metal element with an open cavity.

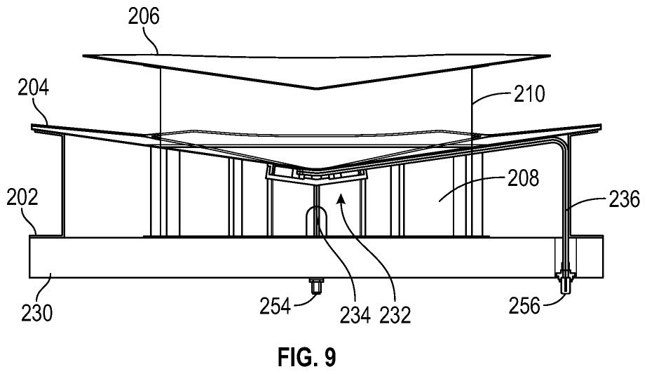

As shown in FIGS. 7 and 9, the conducting ground element 204 is attached to a thin support sheet 205. These are disposed above the base element 202, and are supported by a support element or wall 208. The patch conductor element 206 is attached to a thin support sheet 207. In one embodiment, the support sheets 205, 207 can have a thickness on the order of approximately 0.5 millimeters (mm) or less In alternate embodiments the support sheets 2205, 207 can have any suitable thickness. The support sheets 205, 207 are generally configured to be supported from the ground plane element 204 by a support element or wall 210. The support sheets 205, 207 and the ground element 204 and patch element 206 can be conically shaped for increased structural stiffness.

In one embodiment, the support elements 208, 210 comprise cylindrically formed or shaped composite sheets and be described as supporting pillars. In this example, a thickness of the ground element 204 and the patch conductor 206 is typically on the order of tens of micrometers.

In this example, the sheets 205, 207 and support elements 208, 210 generally comprise a non-conductive dielectric material. In one embodiment, a thickness of the dielectric sheets 205, 207 and support elements 208, 210 can be approximately 0.5 millimeters (mm) or less. The support elements 208, 210 eliminate the need for the standoffs 146 and 148 shown in the example of FIGS. 2 and 3.

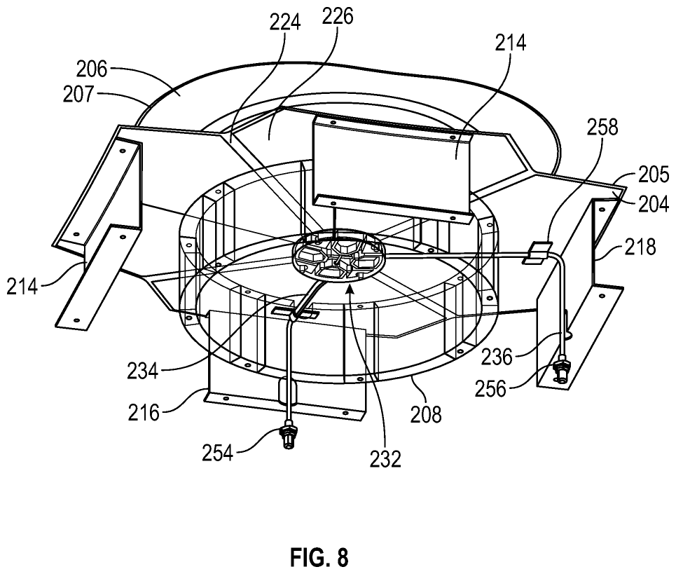

The cavity 212 of the antenna element 200 is configured as an open cavity. Referring also to FIG. 8, in this example, the cavity 212 is opened up with large parts of the cavity walls cut away around the four corners, leaving only minimal sections of the metallic walls, referred to herein as C-section supports 214. The C-section supports 214 also act as a partial support of the ground conductor element 204 and its composite sheet 205. In this embodiment, ground element 204 is situated underneath supporting sheet 205, so as to make electrical contact with C-section supports 214.

Referring to FIG. 8, slots 224 are arranged in the ground conductor element 204. The slots 224 in the ground conductor element 204 are open at their ends. This breaks the ground conductor element 204 into four separate, roughly pentagonal sections, referred to as pentagon sections 226 herein. The slots 224 are generally disposed between the different pentagons 226 of the ground conductor element 204.

In one embodiment, the width of the slots 224 can vary along their length. This variation can help provide optimal impedance matching at the central feed points.

In one embodiment, stiffening fins 228 can be used in conjunction with the support members 208, 210 to enhance the cylinder strength and stiffness. Stiffening fins 228 can be added to the lower support member or pillar 208 as well as the top support pillar or member 210.

The various parts described herein to make up the construction of the antenna element 200 can be bonded together. In an alternate embodiment, the parts can be fastened together using fasteners, not shown in the figures, but indicated by the holes in the parts where applicable.

In one embodiment, the base plate 202 shown in FIG. 7 forms the top face sheet of a thicker base support or element 230. The base support 230 could, for example, consist of top and bottom aluminum face sheets separated by a core of aluminum honeycomb (not shown). Such a lightweight base could form the backbone of a larger array antenna, for example.

The open-ended slots 224 and open cavity 212 shown in FIG. 7 are configured to alter the electrical behavior of the antenna element 200 in terms of electromagnetic coupling between parts, as compared to the antenna element 100 of FIG. 2. However, the general operation of the antenna element 100 and the antenna element 200 can still be explained in terms of a basic cavity-backed slot-coupled-patch mechanism.

Alternatively, the changed geometry of the antenna element 200 with the open cavity 212 can also be viewed as a dipole-coupled-patch arrangement. The open cavity 212 and the open slotted ground arrangement 224 can be viewed as a dual-polarized end-grounded dipole pair. Each dipole is formed by two diagonally opposite pentagonal ground sections 226, which are the monopole arms. The ends of the monopole arms, which are normally free, are grounded to the base plate 202 by the C-section supports 214. The dipole pair, formed by two diagonally opposite pentagonal ground sections 226 is closely nestled, forming the crossed slots 224 between the pentagons 226 of the ground plane element 204.

A dipole needs to be fed in a balanced way, for example, with one monopole arm excited 180 degrees out of phase with respect to the opposite arm. But for practical convenience, an unbalanced coaxial cable is typically used to connect to the antenna, thus each dipole requires a balanced to unbalanced (balun12) feed connection mechanism, which in the classical arrangement usually resides in a central stem leading up to the dipole feed points at the center.

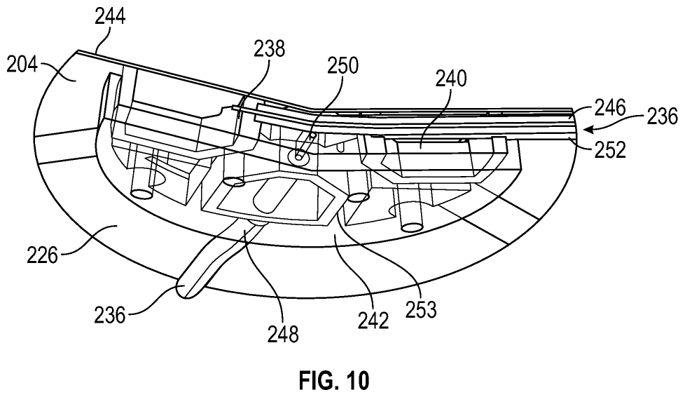

In the embodiment of FIGS. 7-9, the balun is simply in the form of the inner conductors of the coaxial cables 234, 236 bridging the crossed slot gap at the center region 232. As shown in FIG. 8, for example, two of the C-section supports 214, referred to as C-section supports 216 and 218 in this example, provide a path for the two coaxial cables 234 and 236 to approach the central cross-over feed region 232 or bracket 242 of the two nestled dipoles from holes in the base plate 202 and base support 230. Thus, for each dipole as described above, the outer conductor 248, 252 of the respective coaxial cable 234, 236 is connected/grounded to a monopole/pentagonal section, via cable termination piece 253, 240 respectively, as shown in FIG. 10, for example. Likewise the inner conductor 246, 250 of a respective coaxial cable 236, 234 is connected to the corner of the opposing monopole/pentagonal section, via cable termination piece 238 and another not shown in FIG. 10, but oppositely positioned to termination piece 253.

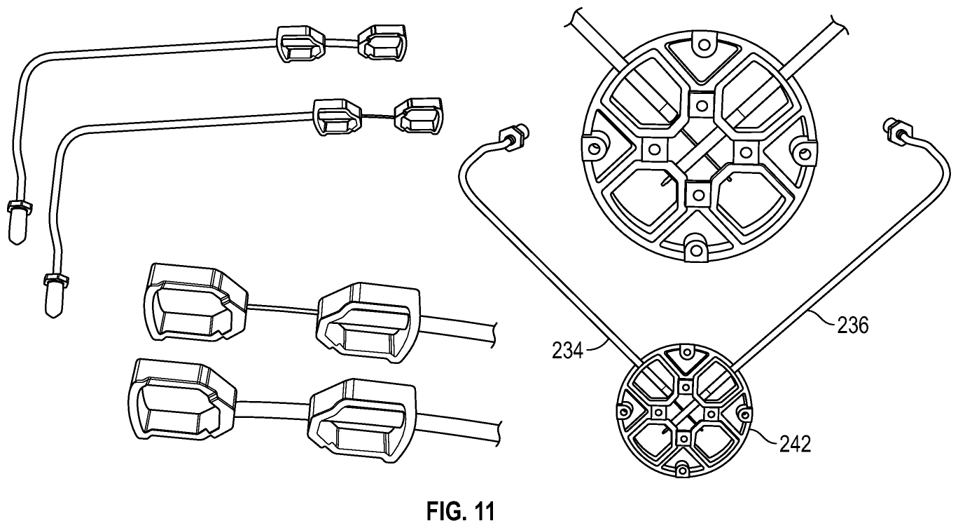

FIG. 11 illustrates a cable assembly showing the cable terminations soldered to the feed cables 234, 236 and inserted into the pockets of a dielectric cross-over bracket 242. This arrangement generally constitutes an “infinite” bandwidth balun, although in practice the final bandwidth is ultimately limited by the dipole response and parasitic capacitances between parts.

Perfect balancing can also be marred if one monopole arm and its feed arrangement is not a perfect mirror symmetry of the opposing arm. The coaxial cables 234 and 236 are configured to be disposed in close proximity to or “hug” the associated C-sections 216, 218 and pentagonal ground sections 226 along their approaching paths to minimize the asymmetry caused by their presence.

In one embodiment, the outer conductor of the coaxial cables 234, 236 should be electrically connected or grounded continuously to the respective pentagon section 226- or C-section support 216, 218 along its path. However, it can be sufficient to have electrical connections or grounding strips 258 intermittently spaced apart at distances significantly shorter than half a wavelength. Thus, with a first connection at the cross-over feed point region 232 or bracket 242 and a second connection at the base plate element 202 connector attachment, it would be sufficient to have a third connection in the form a grounding strip roughly halfway in between, either on the pentagon section 226 of the ground plane element or on the respective C-section support 216, 218.

To facilitate robust and controlled electrical connections of the outer and inner conductors of the coaxial cables 234, 236 at the slot cross-over region 232, small metallic termination pieces 238, 240, 253 shown in FIG. 10 are soldered to the cables and then pressed against the respective pentagon shaped conductors 226 of the ground element 204 with the aid of a non-conducting dielectric cross-over bracket 242, to ensure electrical contact. This also allows for easy disassembly and replacement of the cable parts.

In one embodiment, if the supporting composite sheet material support 205 of the ground plane element 204 can withstand the heat, these termination pieces can be soldered directly to the ground pentagon conductors 226, thereby eliminating the need for a supporting cross-over bracket. In one embodiment, the cable termination pieces can be eliminated by soldering the cable parts directly to the respective pentagon conductors 226 of the ground element 204.

Mechanically, the patch element 206 and pentagon metal parts of the ground element 204 could be in the form of etched copper sheets supported by an approximately 0.5 mm thick or “thin” composite material, curved or formed into cones for mechanical stiffness. Suitable composite materials include, but are not limited to, Kevlar fibers imbedded in a cyanate ester polymer matrix, or commercially available G10, G11 or FR4 sheets. Kevlar composites are significantly lighter and stronger than the commercial sheets, but are more expensive and require more complex manufacturing processes. The commercial materials are available with copper cladding included, while additional steps are required to add a copper layer to Kevlar composite sheets, such as bonding thin copper cladded Kapton sheets to the composite. Due to their heat resistance, copper clad FR4 sheets also may allow direct soldering of the cable terminations to the copper sheets.

### Embodiment 3

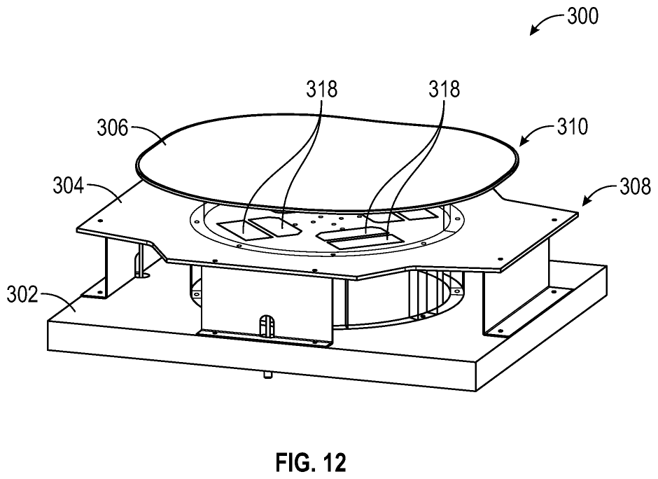

Referring to FIG. 12, an antenna element 300 incorporating aspects of the disclosed embodiments has the same metal topology and electrical operation and performance as the antenna element 200, except that the ground element 304 and the patch conductor element 306 are planar. A planar geometry inherently has less stiffness than a conical geometry of similar thickness. In order to compensate, the respective supporting composite sheets 205, 207 for the ground element 204 and patch element 206 of FIG. 7, are replaced with a respective planar sandwiches 308, 310.

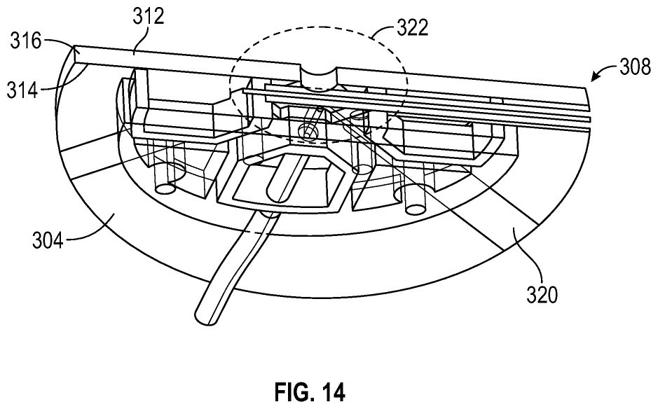

As is shown in FIG. 14, the planar sandwich 308 for the ground element 304 comprises a first or top face sheet 312 and a second or bottom face sheet 314. The face sheets 312, 314 illustrated in FIG. 14 generally constitute composite material face sheets. The top face sheet 312 and the bottom face sheet 314 are bonded to an internal foam core layer 316. Suitable foams of consistent density may include commercially available materials such as Rohacell® or Divinycell foam, for example. Using composite face sheets of only about 0.25 mm thick, and a lightweight foam layer less than 0.5% of a wavelength thick, typically provides sufficient stiffness, and the additional mass penalty is quite small compared to the total mass. An advantage of the antenna element 300 is that etching metal patterns on metal-clad dielectric sheets such as Kapton film or FR4 sheets is preferably done on planar sheets, and the use of planar composite sheets further eliminates the additional cost of fabricating and using special prefabricated molds to form the seamless conical composite sheets required for Embodiment 2.

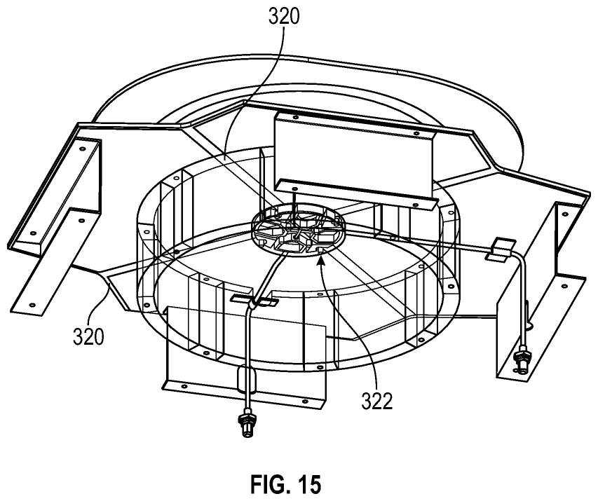

Referring to FIG. 12, the antenna element 300 includes one or more capacitive metallic strips 318, referred to herein as “tune strips”. The tune strips 318 bridge the different slots 320 at specific distances from the central crossing point 322, as shown in FIG. 15. In one embodiment, the tune strips 318 are etched on the top face sheet 312 of the lower sandwich 308, with the supporting the pentagonal shapes of the ground conductor 304. The pentagonal shapes of the ground conductor 304 can be etched on the bottom face sheet 314 shown in FIG. 14. The function of the tune strips 318 is to provide extra capacitance at certain locations in a slot 320. The extra capacitance can be used to fine-tune impedance matching to 50 Ohms (Ω) at the central feed points 322.

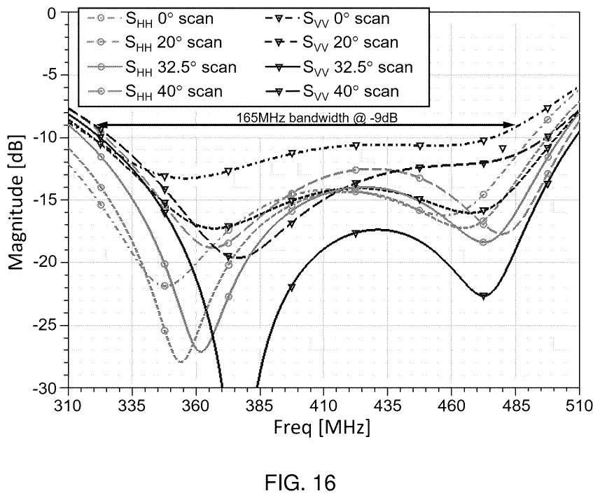

The graphs in FIG. 16 show the predicted active S-parameter performance for the antenna element 300. Namely, the active reflection coefficients at the ports and cross-coupling between ports of an element, placed in an arbitrary large array, with all elements actively excited. The results show that for up to 40 degrees off-boresight beam steering, the active S-parameters are below −9 dB over a 320 MHz-485 MHz band.

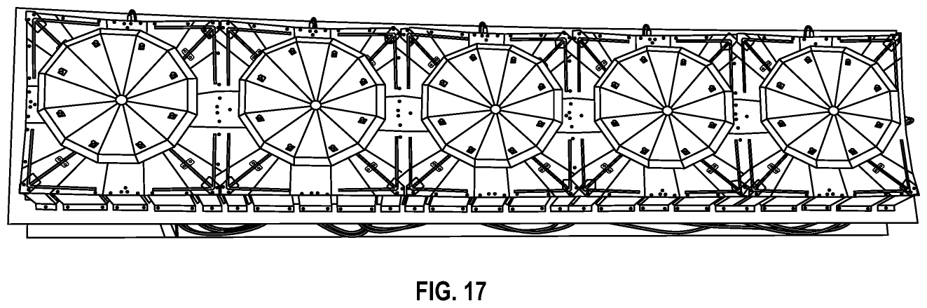

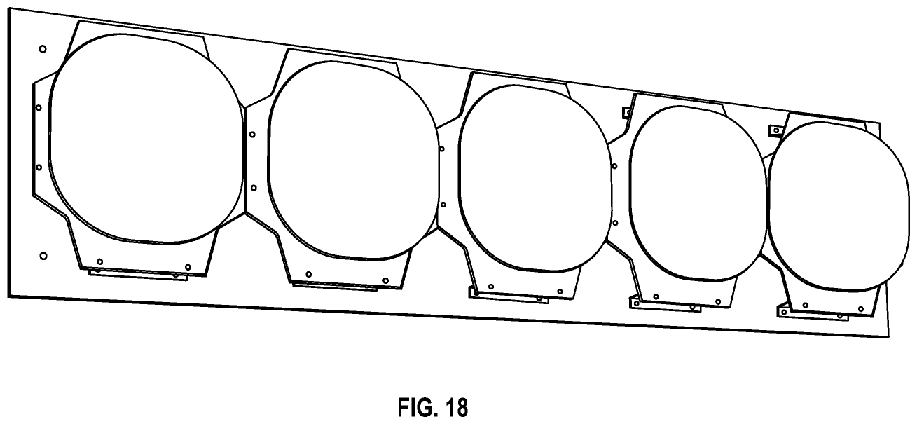

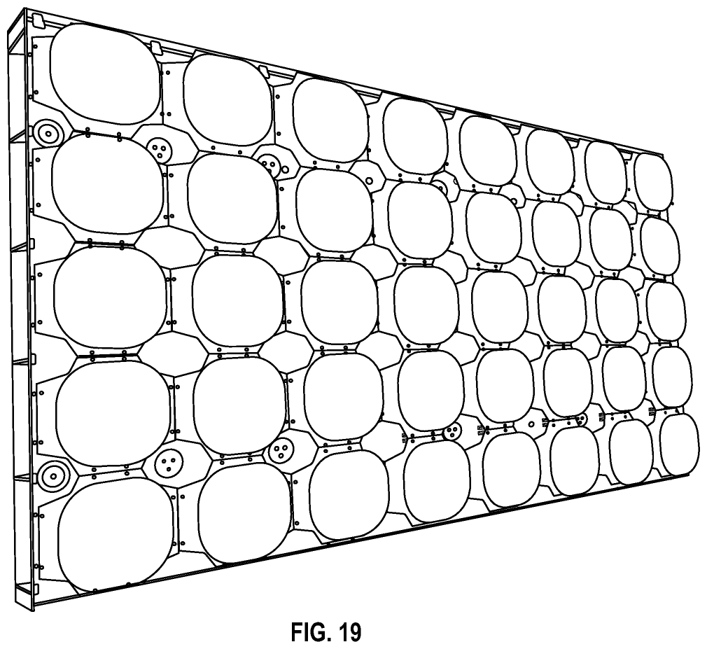

FIG. 17 illustrates an array of five antenna elements 100 of FIGS. 1 and 2. FIG. 18 illustrates an array of five antenna elements 300 and FIG. 19 illustrates a large panel array of forty (40) antenna elements of the disclosed embodiments. The large panel array in FIG. 19 is excited as five (5) sub-arrays of eight (8) elements each. If required, larger or smaller arrays can be built up using several panels positioned side by side in arbitrary configurations.

The aspects of the disclosed embodiments enable antenna arrays to be built up in rows and columns of a lightweight antenna element. The antenna element of the disclosed embodiments is configured to allow beam steering up to the maximum desirable angle without incurring grating lobes in the radiation patterns. In one embodiment, such as for SESAR, beam steering was required in one plane only, with a maximum scan angle of +/−40 degrees off boresight.

For flexible mission planning, a large array can be built from a number of small panels deployable from a folded/stacked stowed configuration during launch to be arranged side by side during operation, where each panel is by itself a fully functional small antenna array. For example, a 5×8 element panel array can have column spacing optimized for up to 40 degrees scanning in the XZ-plane. The number of panels can be chosen as dictated by the particular mission objectives and mission budget.

The antenna element of the disclosed embodiments is generally configured for planetary synthetic aperture radar (SAR) applications, and has particular applicability to the NASA Goddard Space Flight Center (GSFC) Space Exploration Synthetic Aperture Radar (SESAR) instrument. However, the antenna element of the disclosed embodiments is also suitable for earth science applications (i.e., airborne and earth orbiting radar) as well as other RF applications that require beam steering (e.g., communications). The antenna element design combines a novel, mostly planar conductor antenna element geometry with a robust light-weight composite material construction. The antenna element and array design, reported here for P-band operation, can be scaled to other frequencies (e.g., L-, S-, C-, or X-bands) for other radar applications where lightweight and beam agility are required.

Modifications to embodiments of the aspects of the disclosed embodiments described in the foregoing are possible without departing from the scope of the aspects of the disclosed embodiments as defined by the accompanying claims. Expressions such as “including”, “comprising”, “incorporating”, “have”, “is” used to describe and claim the aspects of the disclosed embodiments are intended to be construed in a non-exclusive manner, namely allowing for items, components or elements not explicitly described also to be present. Reference to the singular is also to be construed to relate to the plural.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An antenna apparatus comprising:
a base plate;
a ground element disposed above the base plate; and
a patch antenna element disposed above the base plate; and
one or more slots being formed in corner regions of the ground plane element, wherein the one or more slots being arranged to form an arrow shape in the corner regions.

2. The antenna apparatus according to claim 1, wherein the patch antenna element has a conical shape configured as a faceted cone with a folded rim.

3. The antenna apparatus according to claim 1, wherein the patch antenna is configured as a planar element.

4. The antenna apparatus according to claim 1, wherein the ground plane element is configured as faceted cone elements.

5. The antenna apparatus according to claim 1, wherein the ground plane is configured as a planar element.

6. The antenna apparatus according to claim 5, wherein the ground plane element includes a top face sheet, a bottom face sheet and a foam layer disposed there between.

7. The antenna apparatus according to claim 6, wherein a capacitive metallic strip is disposed across a slot on the top face sheet of the ground plane element.

8. The antenna apparatus according to claim 1, wherein a wall member is disposed between the base plate element and the ground plane element.

9. The antenna apparatus according to claim 8, wherein the wall member includes one or more elongated openings between sections of the wall member.

10. The antenna apparatus according to claim 8, wherein corner regions of the wall member defining openings between sections of the wall member.

11. The antenna element according to claim 1 further comprising a cross-over bracket disposed on an underside of the ground plane element, the cross-over bracket comprising one or more cable terminations for terminating ends of feed cables.

12. The antenna element according to claim 1, wherein the patch antenna element is suspended above the ground element with standoffs.

13. The antenna element according to claim 1, wherein the ground element is supported above the base plate by standoffs.

14. The antenna element according to claim 13, wherein the standoffs comprise metal standoffs.

15. The antenna element according to claim 13, wherein the standoffs comprise dielectric standoffs.
